(19) United States
(12) Patent Application Publication
(10) Pub. No.: US 2024/0355052 A1
(43) Pub. Date: Oct. 24, 2024

(54) AUTOMATIC 3D AVATAR GENERATION BY MESH DEFORMATION BASED ON OPTIMAL TRANSPORT FUNCTION

(71) Applicant: Samsung Electronics Co., Ltd., Suwon-si (KR)

(72) Inventors: Kun Jin, San Jose, CA (US); Siva Penke, San Jose, CA (US)

(21) Appl. No.: 18/610,772

(22) Filed: Mar. 20, 2024

Related U.S. Application Data
(60) Provisional application No. 63/461,462, filed on Apr. 24, 2023.

(51) Int. Cl. G06T 17/20

(52) U.S. Cl. CPC G06T 17/20

(57) ABSTRACT

A method includes obtaining, using at least one processing device of an electronic device, an identification of multiple three-dimensional (3D) objects of interest. The method also includes generating, using the at least one processing device, multiple intermediate 3D objects based on the 3D objects of interest using optimal transport, where the intermediate 3D objects are generated using interpolation or extrapolation based on shapes of the 3D objects of interest. The method further includes presenting, using the at least one processing device, one or more of the intermediate 3D objects to a user.

### CROSS-REFERENCE TO RELATED APPLICATION AND PRIORITY CLAIM

This application claims priority under 35 U.S.C. § 119 (e) to U.S. Provisional Patent Application No. 63/461,462 filed on Apr. 24, 2023, which is hereby incorporated by reference in its entirety.

### TECHNICAL FIELD

This disclosure relates generally to multimedia devices and processes. More specifically, this disclosure relates to automatic three-dimensional (3D) avatar generation by mesh deformation based on an optimal transport (OT) function.

### BACKGROUND

In online virtual communities and other settings, a user may wish to present his or her own three-dimensional (3D) avatar with a unique dressing style, body shape, clothing, etc. Often times, artists, special effects designers, and other personnel have to manually design different body shapes and clothing styles. However, with a growing number of users in online virtual communities and other settings, it is not practical to manually design the massive amount of virtual assets for avatars.

### SUMMARY

This disclosure relates to automatic three-dimensional (3D) avatar generation by mesh deformation based on an optimal transport (OT) function.

In a first embodiment, a method includes obtaining, using at least one processing device of an electronic device, an identification of multiple 3D objects of interest. The method also includes generating, using the at least one processing device, multiple intermediate 3D objects based on the 3D objects of interest using optimal transport, where the intermediate 3D objects are generated using interpolation or extrapolation based on shapes of the 3D objects of interest. The method further includes presenting, using the at least one processing device, one or more of the intermediate 3D objects to a user.

In a second embodiment, an electronic device includes at least one processing device configured to obtain an identification of multiple 3D objects of interest. The at least one processing device is also configured to generate multiple intermediate 3D objects based on the 3D objects of interest using optimal transport, where the at least one processing device is configured to generate the intermediate 3D objects using interpolation or extrapolation based on shapes of the 3D objects of interest. The at least one processing device is further configured to present one or more of the intermediate 3D objects to a user.

In a third embodiment, a non-transitory machine readable medium contains instructions that when executed cause at least one processor of an electronic device to obtain an identification of multiple 3D objects of interest. The non-transitory machine readable medium also contains instructions that when executed cause the at least one processor to generate multiple intermediate 3D objects based on the 3D objects of interest using optimal transport. The instructions that when executed cause the at least one processor to generate the multiple intermediate 3D objects include instructions that when executed cause the at least one processor to generate the intermediate 3D objects using interpolation or extrapolation based on shapes of the 3D objects of interest. The non-transitory machine readable medium further contains instructions that when executed cause the at least one processor to present one or more of the intermediate 3D objects to a user.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example architecture for automatic three-dimensional (3D) avatar generation by mesh deformation based on an optimal transport function in accordance with this disclosure;

FIGS. 3A through 3D illustrate example point clouds and meshes generated using different techniques in accordance with this disclosure;

FIG. 4 illustrates example interpolated outputs based on a source input in accordance with this disclosure;

FIG. 5 illustrates example interpolated and extrapolated outputs based on a source input in accordance with this disclosure; and

FIG. 6 illustrates an example method for automatic 3D avatar generation by mesh deformation based on an optimal transport function in accordance with this disclosure.

### DETAILED DESCRIPTION

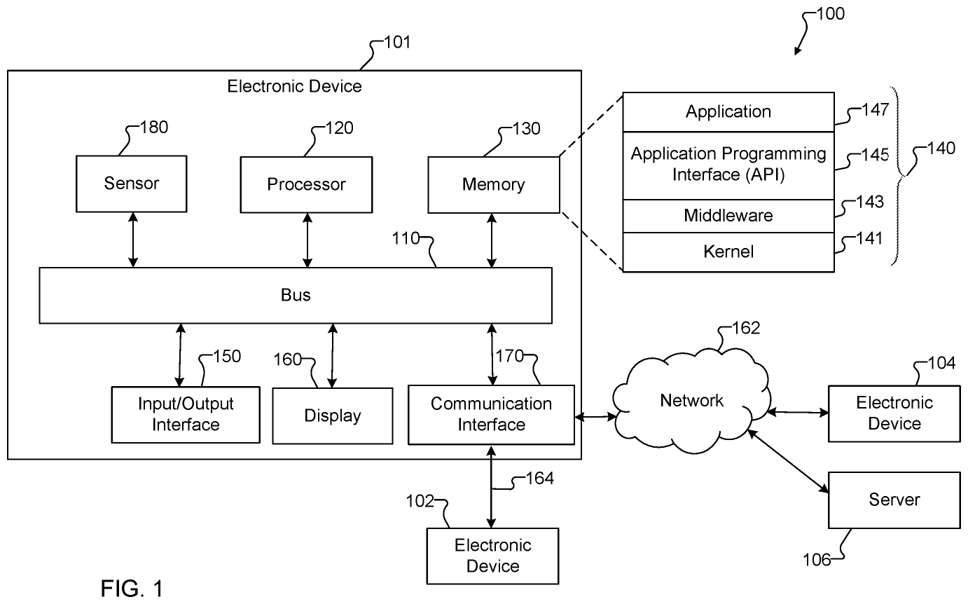

FIGS. 1 through 6, described below, and the various embodiments of this disclosure are described with reference to the accompanying drawings. However, it should be appreciated that this disclosure is not limited to these embodiments and all changes and/or equivalents or replacements thereto also belong to the scope of this disclosure. The same or similar reference denotations may be used to refer to the same or similar elements throughout the specifications and the drawings.

As noted above, in online virtual communities and other settings, a user may wish to present his or her own three-dimensional (3D) avatar with a unique dressing style, body shape, clothing, etc. Often times, artists, special effects designers, and other personnel have to manually design different body shapes and clothing styles. However, with a growing number of users in online virtual communities and other settings, it is not practical to manually design the massive amount of virtual assets for avatars.

One approach for generating virtual assets is to use artificial intelligence (AI)-generated content (AIGC), which requires a tool to automate such a creation process based on deep learning models trained on large datasets. Typically, AIGC-related models generate 3D assets using deep learning. However, AIGC-related models need to train on large-scale training datasets (3D objects), which can be difficult to obtain. Also, AIGC-related models represent learning-based models that are limited to their training domains and that are difficult to generalize to real-world scenarios, which is known as domain adaptation or domain transfer problems. These limitations make expanding the volume of asset databases difficult from scratch.

This disclosure provides various techniques for automatic 3D avatar generation by mesh deformation based on an optimal transport function. As described in more detail below, an identification of multiple 3D objects of interest can be obtained. As one example, the 3D objects of interest may include objects associated with an avatar, such as clothes and accessories for the avatar or furniture to be displayed in association with the avatar. Multiple intermediate 3D objects are generated based on the 3D objects of interest using optimal transport, where the intermediate 3D objects are generated using interpolation or extrapolation based on shapes of the 3D objects of interest. In some cases, an initialization model for the optimal transport can be identified based on a source input object, and the intermediate 3D objects can be generated based on the 3D objects of interest and the initialization model. One or more of the intermediate 3D objects can be presented to a user, such as for selection by the user. The one or more intermediate 3D objects or at least one selected intermediate 3D object may be used in any suitable manner, such as in association with the avatar. In this way, the described techniques allow for more efficient customizations of avatars or other virtual objects.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may generate 3D objects and customized avatars using an optimal transport function.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, generate 3D objects and customized avatars using an optimal transport function. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may generate 3D objects and customized avatars using an optimal transport function.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

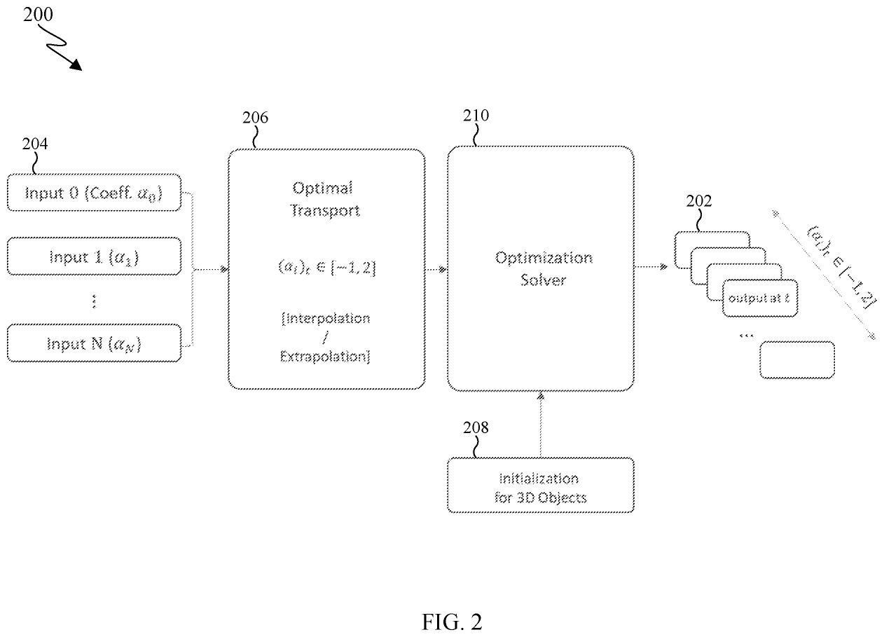

FIG. 2 illustrates an example architecture 200 for automatic 3D avatar generation by mesh deformation based on an optimal transport function in accordance with this disclosure. For case of explanation, the architecture 200 shown in FIG. 2 is described as being implemented on or supported by the electronic device 101 in the network configuration 100 of FIG. 1. However, the architecture 200 shown in FIG. 2 could be used with any other suitable device(s) and in any other suitable system(s), such as when the architecture 200 is implemented on or supported by the server 106.

As shown in FIG. 2, the architecture 200 can be used to generate unique assets, which are referred to as intermediate outputs 202. The intermediate outputs 202 represent objects related to a 3D avatar, such as clothing or accessories to be worn by an avatar or furniture to be placed in a virtual environment in which the avatar is located. The intermediate outputs 202 can be generated on demand based on various inputs 204, which may include 3D objects of interest. An optimal transport function 206 processes the inputs 204, which includes performing interpolation or extrapolation based on shapes of the 3D objects. An initialization function 208 generates an initialization model for use in generating the intermediate outputs 202, where the initialization model is based on a source input object. An optimization solver function 210 processes data from the optimal transport function 206 and the initialization model in order to generate the intermediate outputs 202.

The following details regarding specific implementations of the functions in FIG. 2. Note that the following discussion is focused on using two inputs 204 to generate interpolated and extrapolated intermediate outputs 202. However, any number of inputs 204 can be used in the automatic generation of objects related to a 3D avatar. Furthermore, specific characteristics can be selected from different inputs 204 for interpolation and extrapolation in the intermediate outputs 202.

In some embodiments, the inputs 204 can be associated with two or more assets. For example, the inputs 204 can be associated with or identify clothing, furniture, etc. to be included in or used by or with an avatar. As a particular example, the inputs 204 can include an identification of one or more specific pieces of clothing, such as shoes, pants, shirts, socks, coats/jackets, sweatshirts, hats, jewelry, etc., or furniture to be used by or with the avatar, such as a particular type of table or other piece of furniture. Other inputs 204 can include body parts, such as hair, feet, eyes, nose, cars, torso or body shape, etc. As described below, certain assets may have one or more adjustable features that can be used to customize the assets. For instance, a table asset may have adjustable features like a shape of the table, a shape of the table's legs, an arrangement of the table's legs, a height of the table, or a texture on the table. As another example, a shirt asset may have adjustable features like a taper of the shirt, a texture of the shirt, or a sleeve length. In some embodiments, the inputs 204 can include a selection of one or more of these adjustable features for one or more of the assets. Depending on the implementation, adjustable features can be selected individually or in one or more groups for use during interpolation and extrapolation.

The inputs 204 are provided to the optimal transport function 206, which generally operates to identify a transport plan or plans that can be used when generating an avatar based on the inputs 204. Optimal transport is a process to find a transport plan for transforming one input distribution into another input distribution with least effort, which is also known as a Wasserstein distance. A Wasserstein distance is generally used to measure a discrepancy between two distributions and is denoted as d_{W,τ}. The optimal transport function 206 can interpolate and extrapolate features of a 3D avatar from two or more inputs 204, where the interpolation and extrapolation can be used to generate the intermediate outputs 202. In some embodiments, the optimal transport function 206 can generate the intermediate outputs 202 using interpolation and extrapolation based on the inputs 204 using the following formula.

$$ρ = {inf}_{ρ} ( 1 - t ) {d}_{W , τ} ( {ρ}_{0} , ρ ) + {td}_{W , τ} ( ρ , {ρ}_{1} ) \qquad ( 1 )$$

Here, ρ represents an intermediate output 202, t represents an intensity for the optimal transport, and d_{W,τ} represents a discrepancy between the inputs 204. In particular embodiments, the optimal transport function 206 performs interpolation when 0<t<1 and performs extrapolation when t<0 or t>1. Adjusting the intensity t allows a user to generate different intermediate outputs 202 for a specific set of inputs 204. For example, a game player may select two swords to generate a unique sword. This low-cost unique asset generation can be used to train generative AI models for 3D objects.

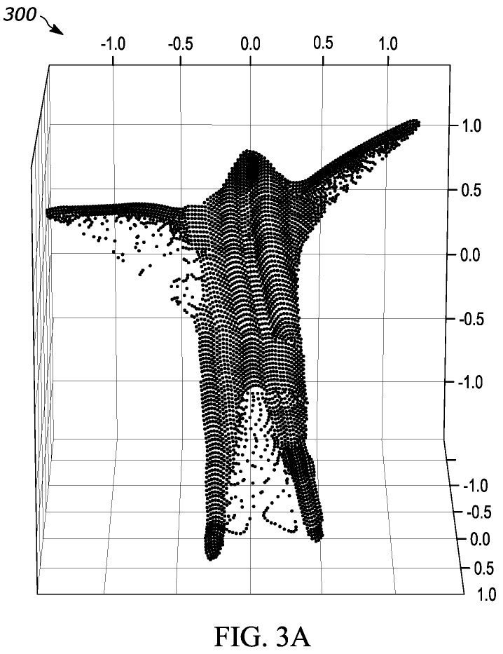

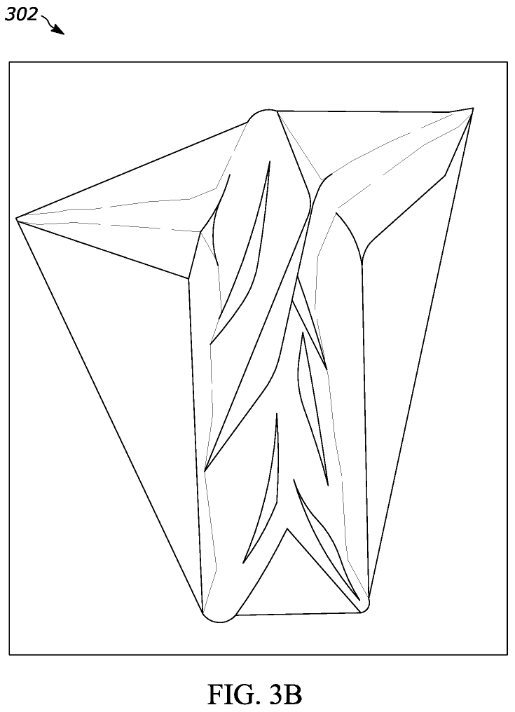

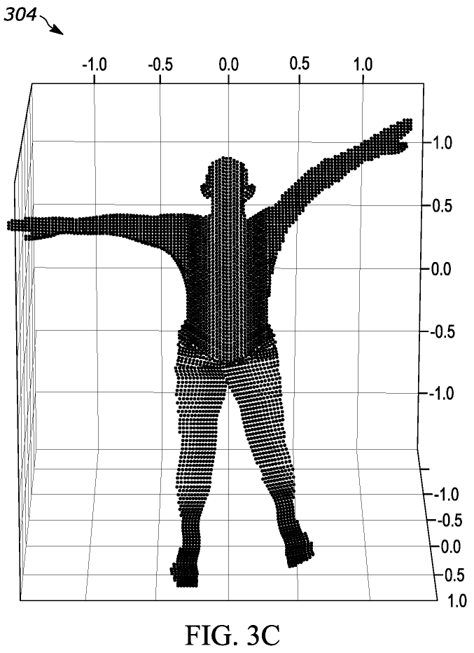

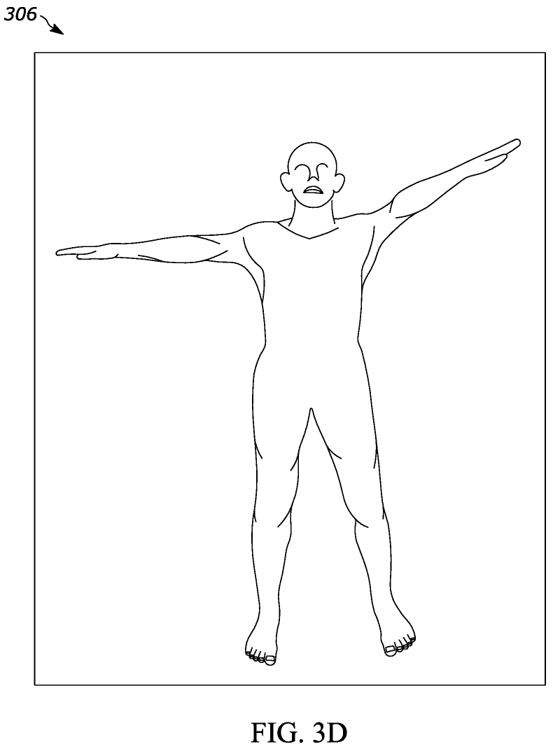

The initialization function 208 generates the initialization model for use in generating the intermediate outputs 202. In some embodiments, the initialization function 208 can use uniform voxels as an initialization model for interpolation and extrapolation. However, a uniform 3D sample used as an initialization model can create a flying vertex due to numeric errors. FIGS. 3A through 3D illustrate example point clouds 300 and 304 and meshes 302 and 306 generated using different techniques in accordance with this disclosure. Examples of a flying vertex are shown in FIGS. 3A and 3B. As shown in FIG. 3A, some mesh vertices are far away or “flying” from an object. The flying vertices cause an output to appear like a kite as shown in FIG. 3B. To avoid the flying vertex problem, a source mesh may be used as the initialization model for objects with similar topologies, which makes solving an optimal transport optimization problem easier than using general uniform sampling as the initialization model for the optimal transport. An example of a source mesh being used to avoid the “flying vertex” problem is shown in FIGS. 3C and 3D. Using the source mesh coincides with a task of mesh deformation, which keeps a topology of the inputs 204 and provides awareness of the target geometry.

The optimization solver function 210 can generate a solution to Equation (1) above, such as by using gradient decent optimization in an iterative manner. In some embodiments, gradient decent optimization can be performed in the following manner.

$${ρ}^{*} = {inf}_{ρ} \{ {\sum }_{i = o}^{N} {α}_{i} {d}_{W , τ} ( {ρ}_{i} , ρ ) \} \qquad ( 2 )$$

Here, ρ* represents an intermediate output 202, i represents a current input 204, αᵢ represents a coefficient associated with the current input 204, and d_{W,τ} represents a discrepancy between the inputs 204. The intermediate output 202 can be generated by the optimization solver function 210 using the uniform voxels from the initialization function 208. The coefficients αᵢ can be adjusted based on t, which is the intensity for the optimal transport. Depending on the implementation, the intensity t can be preset or selected by a user. In some embodiments, multiple values of the intensity t can be used for generating multiple intermediate outputs 202.

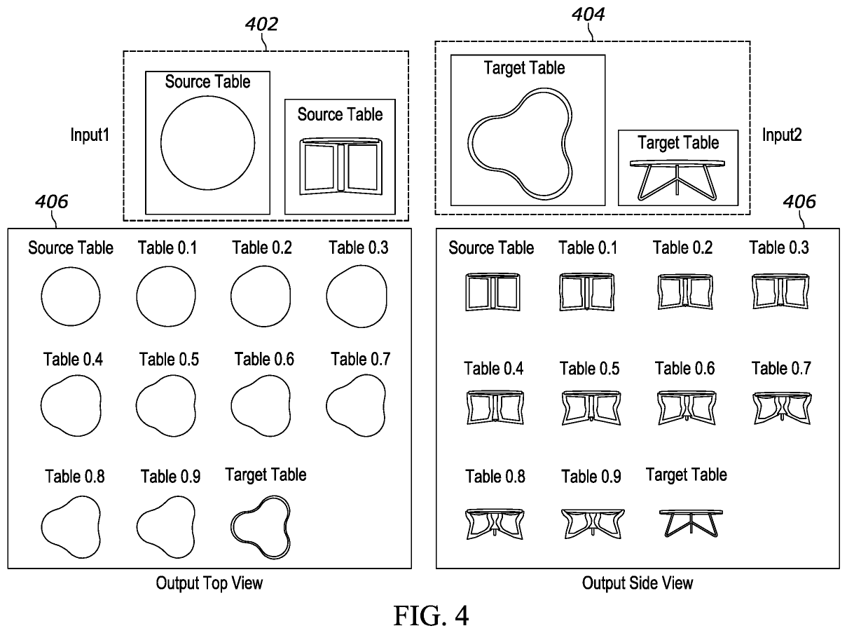

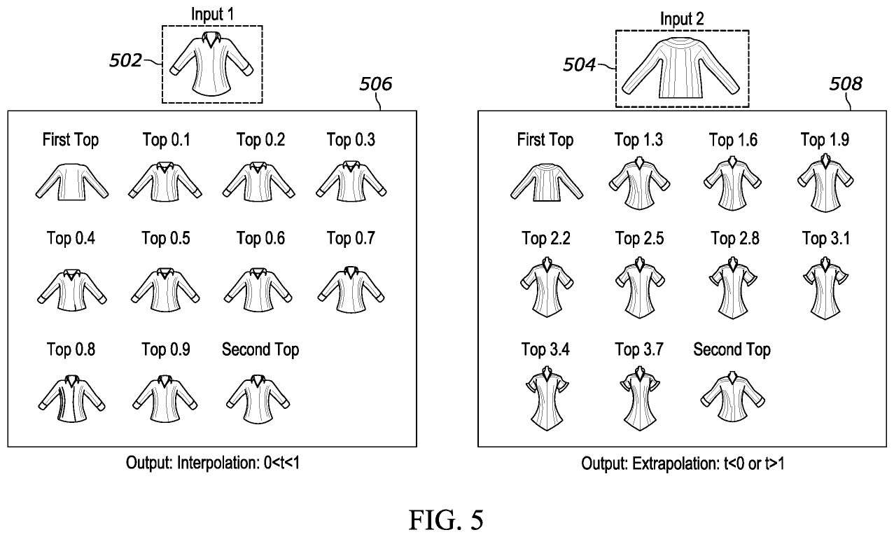

Each intermediate output 202 is a new object interpolated or extrapolated from one or more features of the inputs 204. FIG. 4 illustrates example interpolated outputs based on a source input in accordance with this disclosure, and FIG. 5 illustrates example interpolated and extrapolated outputs based on a source input in accordance with this disclosure. As shown in FIG. 4, a first input table 402 and a second input table 404 are associated with inputs 204 that might be received by the architecture 200. The first and second input tables 402 and 404 can have multiple adjustable features, such as the shape of the table, the shape of its legs, the arrangement of its legs, its height, its texture, etc. The architecture 200 can be used to generate various intermediate outputs 202 in the form of output tables 406 in FIG. 4 via interpolation.

As can be seen in FIG. 4, the output tables 406 include various interpolation iterations from different viewpoints. One input table here can be selected as a source object, such as the first input table 402. Another input table here can be selected as a target object, such as the second input table 404. Interpolation can be performed between the source and target objects. As the intensity t increases, the output tables 406 transform from the source object to the target object. In other words, a lower intensity t produces an output more similar to the first input table 402 than the second input table 404. A higher intensity t produces an output more similar to the second input table 404 than the first input table 402. Each value of the intensity t can produce a different intermediate output 202 that is unique from the first and second input tables 402 and 404.

As shown in FIG. 5, a first input shirt 502 and a second input shirt 504 are associated with other inputs 204 that might be received by the architecture 200. The first and second input shirts 502 and 504 can have multiple adjustable features, such as its taper, its texture, or its sleeve length. The architecture 200 can be used to generate various intermediate outputs 202 in the form of output shirts 506 in FIG. 5 via interpolation and output shirts 508 in FIG. 5 via extrapolation.

As can be seen in FIG. 5, the first output shirts 506 are interpolations of the first and second input shirts 502 and 504, and the second output shirts 508 are extrapolations of the first and second input shirts 502 and 504. The first output shirts 506 show transitions between the first input shirt 502 and the second input shirt 504 when the intensity t is 0<t<1. The second output shirts 508 include representations of shirts transitioning from the second input shirt 504 away from the first input shirt 502 when the intensity t is t>1. The second output shirts 508 may also or alternatively include representations of shirts transitioning from the first input shirt 502 away from the second input shirt 504 when the intensity t is t<0.

The intermediate outputs 202 that are generated in this manner can be used in any suitable manner. For example, the intermediate outputs 202 can be presented to the user of the electronic device 101 for selection, and an avatar associated with the user can be updated based on the user's selection(s) of one or more of the intermediate outputs 202. The inputs 204 that are used to generate the intermediate outputs 202 can also be obtained in any suitable manner. For instance, the inputs 204 may be based on 3D objects of interest, such as 3D objects selected by a user. In some cases, the objects can be selected from one or more objects in a virtual environment in which the user's avatar is located or from a different source, such as the Internet or from an object stored in the memory 130 of the electronic device 101. In some embodiments, a 3D object can be identified in a virtual environment that the avatar is located in as a primary object, and a 3D object from outside of the virtual environment can be identified as a secondary object. Also, in some embodiments, objects can be selected from a list of objects. For example, the user could search for “tables,” and a list of tables can be presented to the user for selecting a first table and a second table for interpolation or extrapolation.

Although FIGS. 2 through 5 illustrate one example of an architecture 200 for automatic 3D avatar generation by mesh deformation based on an optimal transport function and related details, various changes may be made to FIGS. 2 through 5. For example, any two or more objects can be used as inputs 204 to generate intermediate outputs 202. Also, specific aspects of the inputs 204 can be selected for altering the generation of the intermediate outputs 202.

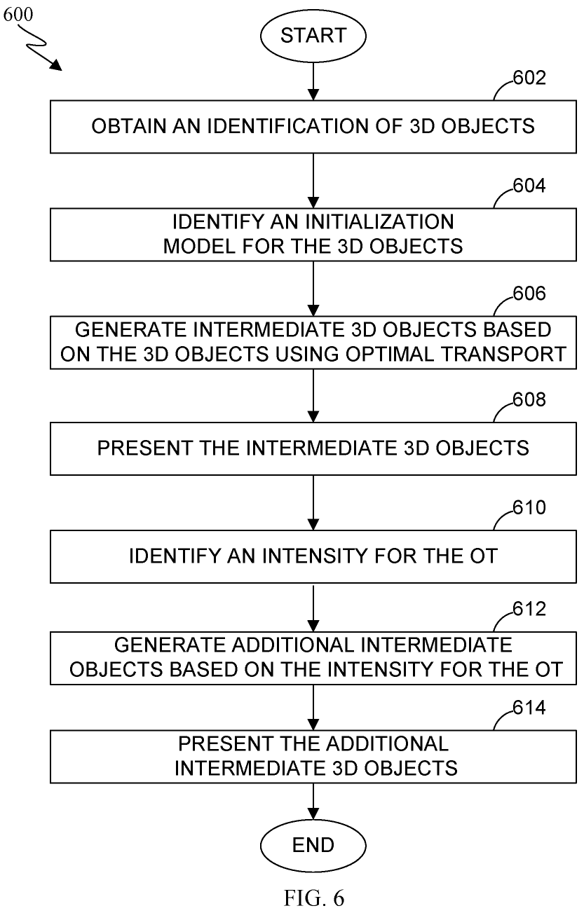

FIG. 6 illustrates an example method 600 for automatic 3D avatar generation by mesh deformation based on an optimal transport function in accordance with this disclosure. For case of explanation, the method 600 shown in FIG. 6 is described as being performed by the electronic device 101 in the network configuration 100 of FIG. 1. However, the method 600 shown in FIG. 6 could be performed by any other suitable device(s) and in any other suitable system(s), such as when the method 600 is performed using the server 106 shown in FIG. 1.

As shown in FIG. 6, the electronic device 101 can obtain an identification of 3D objects of interest in step 602. The multiple 3D objects of interest can include a first object and a second object, where the first input object and second input object have similar identifiable features. The 3D objects of interest include objects associated with an avatar, such as clothes and accessories for the avatar and furniture to be displayed in association with the avatar. In some embodiments, a first object selected is a source input object. The source input object can be an object identified by a user or selected based on an object name. A second input object can be selected, such as from a scene, from a list of objects with similar characteristics, or from storage. For example, a first table can be identified or searched for in a database of objects, and a second table can be identified from the scene or from the database of objects. The database of objects can be sorted based on objects that represent tables, and the first or second object can be selected from the objects that represent tables. Examples of inputs can include objects related to an avatar, such as hair, clothing, body shape, accessories, etc. and objects for an avatar to interact with, such as tools, furniture, weapons, armor, vehicles, structures, plants, animals, etc. The 3D objects can correspond to the inputs 204 shown in FIG. 2, examples of which may include the first and second input tables 402 and 404 shown in FIG. 4 and the first and second input shirts 502 and 504 shown in FIG. 5.

The electronic device 101 can optionally identify an initialization model for a source object in step 604. For example, the initialization model may be identified for the first input object. In some cases, the initialization model can include coefficients and vertices used to avoid the “flying vertex” problem in mesh and object models. In some embodiments, multiple initialization models can be identified when multiple adjustable features are selected for different objects.

The electronic device 101 can generate intermediate objects based on the 3D objects using optimal transport in step 606. The multiple intermediate 3D objects can be generated based on the 3D objects of interest using optimal transport. For example, the intermediate 3D objects can be generated using interpolation or extrapolation based on shapes of the 3D objects of interest. In some cases, the intermediate 3D objects can be generated based on one or more of the 3D objects of interest and the intensity using the optimal transport. The intermediate objects can be presented interacting with the avatar, proximate to the avatar, or in a separate interface. The intermediate objects can be generated based on one or more preset intensities for the optimal transport.

The electronic device 101 can present the intermediate 3D objects at step 608. At least one intermediate object, such as intermediate output 202, can be generated using an OT function with the first and second input objects and the identified initialization model, where the at least one intermediate object is an interpolation or an extrapolation of the first and second input objects 204. Examples of the intermediate object 202 can include intermediate output 202, an object from output tables 406, and an object from the first and second output shirts 506 and 508.

The electronic device 101 can optionally identify an intensity to be used by an optimal transport function in step 610. The optimal transport can have an intensity that controls a weight of the interpolation and/or extrapolation of the first 3D object and the second 3D objects. Depending on the implementation, the intensity for the optimal transport may be received from a user, represent a preset intensity retrieved from memory, or may be set in any other suitable manner. If the intensity is adjusted, the electronic device 101 can generate one or more additional intermediate objects based on one or more of the 3D objects of interest and the intensity in step 612, and the one or more additional intermediate objects can be presented in step 614.

A presented intermediate object or presented additional intermediate object can be used in any suitable manner. For example, the presented intermediate object or presented additional intermediate object may be assigned to or manipulated by the avatar. As a particular example, hair, body shape, clothing, and accessories can be moved corresponding to movements of the avatar. The intermediate objects can also be presented in a virtual environment in which the avatar is located. This may allow, for instance, the avatar to interact with furniture, structures, vehicles, or other surrounding objects in the virtual environment.

Although FIG. 6 illustrates one example of a method 600 for automatic 3D avatar generation by mesh deformation based on an optimal transport function, various changes may be made to FIG. 6. For example, while shown as a series of steps, various steps in FIG. 6 may overlap, occur in parallel, occur in a different order, or occur any number of times (including zero times).

It should be noted that the functions shown in or described with respect to FIGS. 2 through 6 can be implemented in an electronic device 101, server 106, or other device in any suitable manner. For example, in some embodiments, at least some of the functions shown in or described with respect to FIGS. 2 through 6 can be implemented or supported using one or more software applications or other software instructions that are executed by the processor 120 of the electronic device 101, server 106, or other device. In other embodiments, at least some of the functions shown in or described with respect to FIGS. 2 through 6 can be implemented or supported using dedicated hardware components. In general, the functions shown in or described with respect to FIGS. 2 through 6 can be performed using any suitable hardware or any suitable combination of hardware and software/firmware instructions. Also, the functions shown in or described with respect to FIGS. 2 through 6 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, an identification of multiple three-dimensional (3D) objects of interest;
generating, using the at least one processing device, multiple intermediate 3D objects based on the 3D objects of interest using optimal transport, wherein the intermediate 3D objects are generated using interpolation or extrapolation based on shapes of the 3D objects of interest; and
presenting, using the at least one processing device, one or more of the intermediate 3D objects to a user.

2. The method of claim 1, wherein the 3D objects of interest comprise objects associated with an avatar.

3. The method of claim 2, wherein the objects associated with the avatar comprise clothes and accessories for the avatar.

4. The method of claim 2, wherein the objects associated with the avatar comprise furniture to be displayed in association with the avatar.

5. The method of claim 1, wherein the optimal transport is performed using a formula of:
$${ρ}^{*} = {inf}_{ρ} \{ {\sum }_{i = 0}^{N} {α}_{i} {d}_{W , τ} ( {ρ}_{i} , ρ ) \}$$
where ρ* represents a specified one of the intermediate 3D objects, i represents a specified one of the 3D objects of interest, αᵢ represents a coefficient associated with the specified 3D object of interest, and d_{W,τ} represents a discrepancy between the 3D objects of interest.

6. The method of claim 1, further comprising:
identifying an initialization model for the optimal transport based on a source input object;
wherein generating the intermediate 3D objects comprises generating the intermediate 3D objects based on the 3D objects of interest and the initialization model.

7. The method of claim 1, further comprising:
receiving an intensity for the optimal transport;
generating one or more additional intermediate 3D objects based on one or more of the 3D objects of interest and the intensity using the optimal transport; and
presenting at least one of the one or more additional intermediate 3D object to the user.

8. An electronic device comprising:
at least one processing device configured to:
obtain an identification of multiple three-dimensional (3D) objects of interest;
generate multiple intermediate 3D objects based on the 3D objects of interest using optimal transport, wherein the at least one processing device is configured to generate the intermediate 3D objects using interpolation or extrapolation based on shapes of the 3D objects of interest; and
present one or more of the intermediate 3D objects to a user.

9. The electronic device of claim 8, wherein the 3D objects of interest comprise objects associated with an avatar.

10. The electronic device of claim 9, wherein the objects associated with the avatar comprise clothes and accessories for the avatar.

11. The electronic device of claim 9, wherein the objects associated with the avatar comprise furniture to be displayed in association with the avatar.

12. The electronic device of claim 8, wherein the at least one processing device is configured to perform the optimal transport using a formula of:
$${ρ}^{*} = {inf}_{ρ} \{ {\sum }_{i = 0}^{N} {α}_{i} {d}_{W , τ} ( {ρ}_{i} , ρ ) \}$$
where ρ* represents a specified one of the intermediate 3D objects, i represents a specified one of the 3D objects of interest, αᵢ represents a coefficient associated with the specified 3D object of interest, and d_{W,τ} represents a discrepancy between the 3D objects of interest.

13. The electronic device of claim 8, wherein:
the at least one processing device is further configured to identify an initialization model for the optimal transport based on a source input object; and
the at least one processing device is configured to generate the intermediate 3D objects based on the 3D objects of interest and the initialization model.

14. The electronic device of claim 8, wherein the at least one processing device is further configured to:
receive an intensity for the optimal transport;
generate one or more additional intermediate 3D objects based on one or more of the 3D objects of interest and the intensity using the optimal transport; and
present at least one of the one or more additional intermediate 3D object to the user.

15. A non-transitory machine readable medium containing instructions that when executed cause at least one processor to:
obtain an identification of multiple three-dimensional (3D) objects of interest;
generate multiple intermediate 3D objects based on the 3D objects of interest using optimal transport, wherein the instructions that when executed cause the at least one processor to generate the multiple intermediate 3D objects comprise instructions that when executed cause the at least one processor to generate the intermediate 3D objects using interpolation or extrapolation based on shapes of the 3D objects of interest; and
present one or more of the intermediate 3D objects to a user.

16. The non-transitory machine readable medium of claim 15, wherein the 3D objects of interest comprise objects associated with an avatar.

17. The non-transitory machine readable medium of claim 16, wherein the objects associated with the avatar comprise at least one of:
clothes and accessories for the avatar; and
furniture to be displayed in association with the avatar.

18. The non-transitory machine readable medium of claim 15, wherein the instructions when executed cause the at least one processor to perform the optimal transport using a formula of:
$${ρ}^{*} = {inf}_{ρ} \{ {\sum }_{i = 0}^{N} {α}_{i} {d}_{W , τ} ( {ρ}_{i} , ρ ) \}$$
where ρ* represents a specified one of the intermediate 3D objects, i represents a specified one of the 3D objects of interest, αᵢ represents a coefficient associated with the specified 3D object of interest, and d_{W,τ} represents a discrepancy between the 3D objects of interest.

19. The non-transitory machine readable medium of claim 15, further containing instructions that when executed cause the at least one processor to identify an initialization model for the optimal transport based on a source input object; and
the instructions that when executed cause the at least one processor to generate the intermediate 3D objects comprise instructions that when executed cause the at least one processor to generate the intermediate 3D objects based on the 3D objects of interest and the initialization model.

20. The non-transitory machine readable medium of claim 15, further containing instructions that when executed cause the at least one processor to:
receive an intensity for the optimal transport;
generate one or more additional intermediate 3D objects based on one or more of the 3D objects of interest and the intensity using the optimal transport; and
present at least one of the one or more additional intermediate 3D object to the user.
